(19) United States
(12) Patent Application Publication
(10) Pub. No.: US 2026/0184156 A1
(43) Pub. Date: Jul. 2, 2026

(54) UTILITY VEHICLE

(71) Applicant: KUBOTA CORPORATION, Osaka-shi (JP)

(72) Inventors: Max MCCAMMON, Gainesville, GA (US); Dillan BROCK, Gainesville, GA (US); Nicholas ALLICOCK, Lawrenceville, GA (US); Connor HENDERSON, Lula, GA (US)

(73) Assignee: KUBOTA CORPORATION, Osaka-shi (JP)

(21) Appl. No.: 19/004,443

(22) Filed: Dec. 29, 2024

(51) Int. Cl. B60K 1/04; B60K 17/04; B60L 15/00

(52) U.S. Cl. CPC B60K 1/04; B60K 17/04; B60L 15/007; B60K 2001/0422

(57) ABSTRACT

A utility vehicle includes an electric motor provided on a frame body under a cargo bed in a vertical direction such that the electric motor does not overlap with the rear wheels as viewed in a left-right direction. A transmission is mounted to the frame body. The transmission includes an input shaft to receive a driving power of an output shaft of the electric motor to output a rotational power of the rear wheels. The output shaft and the input shaft extend in the left-right direction such that the input shaft is apart from the output shaft in a front-back direction. The at least one battery is electrically connected to the electric motor and provided under the seat in a vertical direction such that the electric motor is provided between the at least one battery and the transmission in the front-back direction.

### BACKGROUND

### Technical Field

The present invention relates to a utility vehicle, more specifically a utility vehicle having a utility vehicle powered by an electric motor.

### Discussion of the Background

Utility vehicles powered by electric motors are increasing.

### SUMMARY

In accordance with one aspect of the present disclosure, a utility vehicle includes a frame body, a seat, a cargo bed, rear wheels, an electric motor, a transmission, and at least one battery. The seat is provided on the frame body. A person is seated on the seat. The cargo bed is mounted to the frame body in back of the seat. The seat and the cargo bed is aligned in a front-back direction. The rear wheels are aligned in a left-right direction perpendicular to front-back direction. The rear wheels are rotatably mounted to the frame body under the cargo bed in a vertical direction perpendicular to the front-back direction and to the left-right direction. The electric motor is provided on the frame body under the cargo bed in the vertical direction such that the electric motor does not overlap with the rear wheels as viewed in the left-right direction. The electric motor includes an output shaft which the electric motor is configured to rotate and which extends in the left-right direction. The transmission is mounted to the frame body under the cargo bed in the vertical direction. The transmission includes an input shaft to receive a driving power of the output shaft to output a rotational power of the rear wheels. The input shaft extends in the left-right direction such that the input shaft is apart from the output shaft in the front-back direction and substantially parallel to the output shaft. The at least one battery is electrically connected to the electric motor and provided under the seat in the vertical direction such that the electric motor is provided between the at least one battery and the transmission in the front-back direction.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 shows a left side view of a utility vehicle.

FIG. 2 shows a plan view of the utility vehicle.

FIG. 3 shows a rear view of the utility vehicle.

FIG. 4 shows a perspective view of the rear portion of the utility vehicle with the seats, the rear wheels and the cargo bed omitted.

FIG. 5 shows a plan view of the rear portion of the utility vehicle with the seats, the rear wheels and the cargo bed omitted.

FIG. 6 shows a left side view of the rear portion of the utility vehicle with the rear wheels, the cargo bed, the PDU, the left rear cover, and the left supporting platform omitted.

FIG. 7 shows a front upward perspective view of the prime mover compartment of the utility vehicle with the main frames attached.

FIG. 8 shows a left side view of the rear portion of the utility vehicle with the rear wheels, the cargo bed and the left supporting platform omitted.

FIG. 9 shows a front view of the at least one battery and the battery mounting unit.

FIG. 10 shows a right side view of the rear portion of the utility vehicle with the rear wheels and the cargo bed omitted.

FIG. 11 shows a perspective view of the battery mounting unit.

FIG. 12 shows a front view of the at least one battery and the battery mounting unit with the floor frame and stands to support the floor frame.

### DESCRIPTION OF THE EMBODIMENTS

### Overall Configuration of the Utility Vehicle

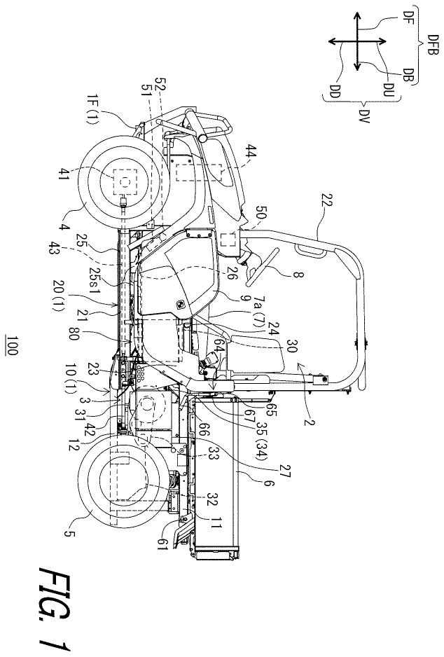

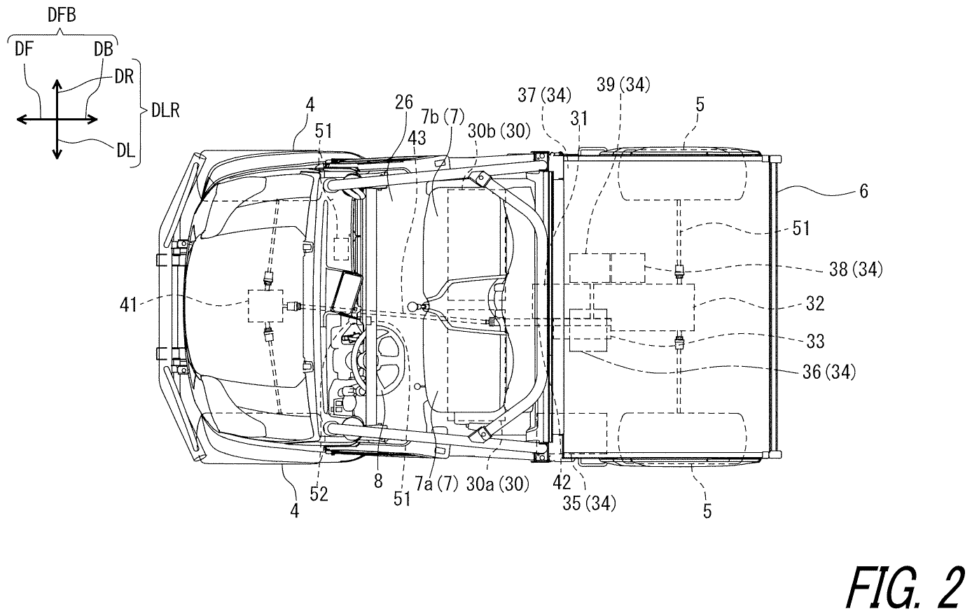

FIGS. 1 and 2 show the utility vehicle 100 exemplarily described in the present embodiment. The utility vehicle 100 is used for carrying luggage, recreation, or etc. The utility vehicle 100 includes: a frame body 1, an operator compartment 2, a prime mover compartment 3, front wheels 4, right rear wheels 5, and a cargo bed 6. The frame body 1 is constituted by several frames to define and the operator compartment 2 and the prime mover compartment 3. The operator compartment 2 is located at a middle portion of the frame body 1 and includes seats 7, and steering wheel 8, and doors 9. The seats 7 include a driver's seat 7a disposed on the left side and a passenger's seat 7b disposed on the right side. The steering wheel 8 is operably coupled to the front wheels 4 for steering them. The doors 9 covers a front side portion of the operator compartment 2 and configured to be opened and closed by the driver and the passenger.

In the following description, the front-back direction DFB (forward direction DF/backward direction DB) means a front-back direction (forward direction/backward direction) as viewed from a driver seated on the driver's seat 7a. A leftward direction DL, a rightward direction DR, a left-right direction DLR means the left direction, the right direction, and the left-right direction as viewed from the driver, respectively. An upward direction DU, a downward direction DD, vertical direction DV means an upward direction, a downward direction, and a vertical direction as viewed from the driver. The left-right direction DLR is perpendicular to front-back direction DFB. The vertical direction DV is perpendicular to the front-back direction DFB and to the left-right direction DLR.

In this embodiment, the operator compartment 2 further accommodates the at least one battery 30 provided under the seats 7 in the vertical direction DV. The at least one battery 30 is a high voltage lithium-ion battery. For example, the at least one battery 30 is a 48-volt lithium-ion battery. However, the at least one battery 30 may be an 80-volt lithium-ion battery. More specifically, the at least one battery 30 includes a first battery 30a provided under the driver's seat 7a and a second battery 30b provided under the passenger's seat 7b.

The prime mover compartment 3 is located behind the operator compartment 2 in the front-back direction DFB and under the cargo bed 6 in the vertical direction DV. The prime mover compartment 3 accommodates an electric motor 31, a transmission 32, an additional speed changer 33, and at least one electric component 34. The electric motor 31 is electrically connected to the at least one battery 30. The electric motor 31 is configured to receive electric power from the at least one battery 30 to generate motive power. For example, the electric motor 31 is an alternating-current motor that is operable under alternating-current electric power supplied from the at least one battery 30. A driving voltage of the electric motor 31 is equal to a voltage supplied by the at least one battery 30.

The transmission 32 is provided behind the electric motor 31 in the front-back direction DFB such that the electric motor 31 is provided between the at least one battery 30 and the transmission 32 in the front-back direction DFB. More specifically, the electric motor 31 is provided between the transmission 32 and each of the first battery 30a and the second battery 30b in the front-back direction DFB. The transmission 32 includes, inside its casing, a gear type speed changer mechanism capable of switching between forward traveling and reverse traveling and also switching in two steps of high and low in the forward and reverse traveling powers. The transmission 32 further includes power distribution mechanism for dividing speed-changed power from the gear type speed changer mechanism to a front wheel driving power and a rear wheel driving power and a front wheel clutch for transmitting or non-transmitting power to the front wheels 4. The additional speed changer 33 is a belt-type speed changer to transmit the motive power generated by the electric motor 31 to the transmission 32. The internal structure of the additional speed changer 33 is explained later.

As shown in FIG. 2, the at least one electric component 34 includes a power distribution unit (PDU) 35, an inverter 36, an additional battery 37, a DC-to-DC converter 38, and an on-board charger 39. The PDU 35 is provided between the at least one battery 30 and the transmission 32 in the front-back direction DFB. The PDU 35 is electrically connected to the at least one battery 30, the inverter 36, the additional battery 37, the DC-to-DC converter 38, and the on-board charger 39. The PDU 35 is configured to distribute the high voltage from the at least one battery 30 to the inverter 36. In other words, the PDU 35 is configured to distribute electric power from the at least one battery 30 to the inverter 36.

The inverter 36 is configured to receive the high voltage from the at least one battery 30 to output drive control current (e.g. a PWM signal (pulse-width modulation signal) to the electric motor 31. The inverter 36 is configured to receive a control signal from an electric control unit 50 (referred to as “ECU 50” hereinafter) based on a depression amount of the accelerator pedal 51. The ECU 50 is configured to receive an output of a pedal sensor 52 to detect the depression amount. Then, the ECU 50 is configured to generate the control signal based on the depression amount etc. to control the number of revolutions of the electric motor 31. In FIGS. 1 and 2, the ECU 50 is depicted as a mere example. The ECU 50 may be disposed in a different position from that depicted in FIGS. 1 and 2.

The additional battery 37 is a low voltage lead-acid battery. For example, the additional battery 37 is a 12-volt lead-acid battery to supply electric power to 12-volt electric components, such as the ECU 50. The DC-to-DC converter (direct current to direct current converter) 38 is configured to convert the output voltage of the at least one battery 30 into a voltage corresponding to the additional battery 37. The on-board charger 39 is an alternator configured to generate alternating-current electricity using power from the electric motor 31 and to convert the alternating-current electricity into direct-current electricity using a rectifier. The PDU 35 is configured to receive the electric power converted by the DC-to-DC converter 38 and generated by the on-board charger 39 to distribute the electric power to the additional battery 37.

The front wheels 4 are steerable based on operation of the steering wheel 8. The front wheels 4 are connected to a differential device 41. The transmission 32 has a forwardly extending output shaft 42 for driving the front wheels 4 provided at a left end portion of a front lower portion of the transmission 32. The differential device 41 and the forwardly extending output shaft 42 are connected by a front wheel transmission line 43 to transmit the front wheel driving power generated by the transmission 32. Accordingly, the front wheels 4 may be driven by power from the transmission 32.

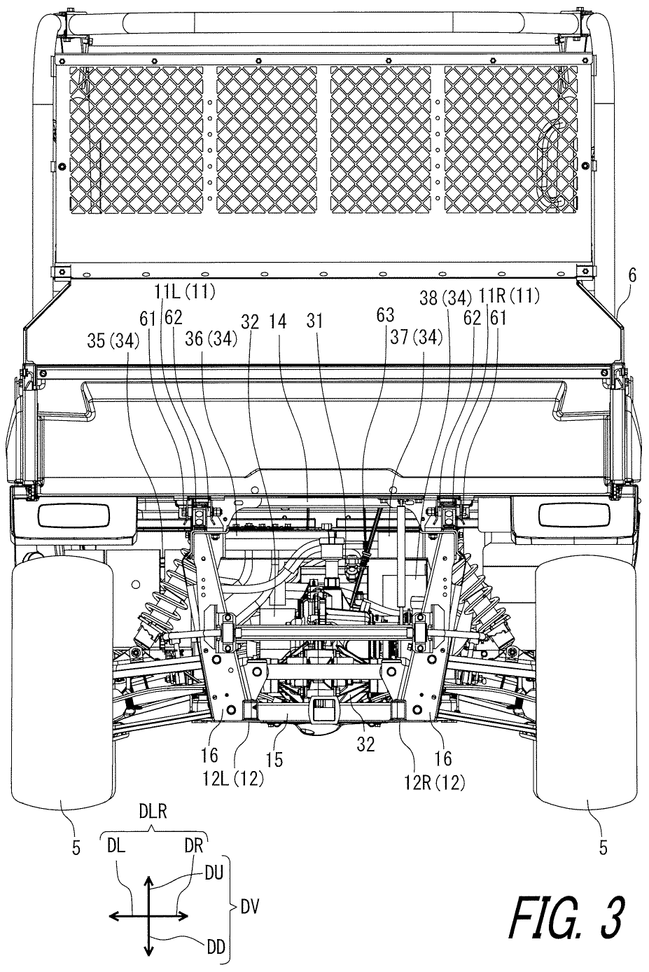

The rear wheels 5 is connected to an output shaft of the transmission 32 and configured to be driven by power from the transmission 32. The rear wheels 5 are aligned in the left-right direction DLR. The cargo bed 6 is coupled to a rear portion of the frame body 1 in a vertically swingable manner. More specifically, as shown in FIG. 3, the cargo bed 6 is pivotally liftably supported by bosses 61 of the frame body 1 via bolts 62 functioning as right/left oriented support shafts, respectively. The utility vehicle 100 includes the electro-gas cylinder 63 to lift up/down the cargo bed 6. Furthermore, as shown in FIG. 1, the utility vehicle 100 further includes locking mechanisms 64 for locking the cargo bed 6 at the load-carrying position. The mechanisms 64 are configured as a toggle type arrangement. The toggle type arrangement includes hooks 65, lock levers 66, and frame members 67. The hooks 65 are disposed at right and left end portions of the front end portion of the cargo bed 6. The lock levers 69 are disposed at frame body 1. The frame members 67 are provided in the respective lock levers 69 to be hooked to the hooks 68, and so on.

As shown in FIG. 1, the cargo bed 6 is mounted to the frame body 1 in back of the seats 7. The seats 7 and the cargo bed 6 are aligned in the front-back direction DFB. The rear wheels are rotatably mounted to the frame body 1 under the cargo bed 6 in the vertical direction DV. As shown in FIG. 1, the electric motor 31 provided on the frame body 1 under the cargo bed 6 in the vertical direction DV such that the electric motor 31 does not overlap with the rear wheels 5 as viewed in the left-right direction DLR. The transmission 32 is mounted to the frame body 1 under the cargo bed 6 in the vertical direction DV.

### Structure of the Frame Body

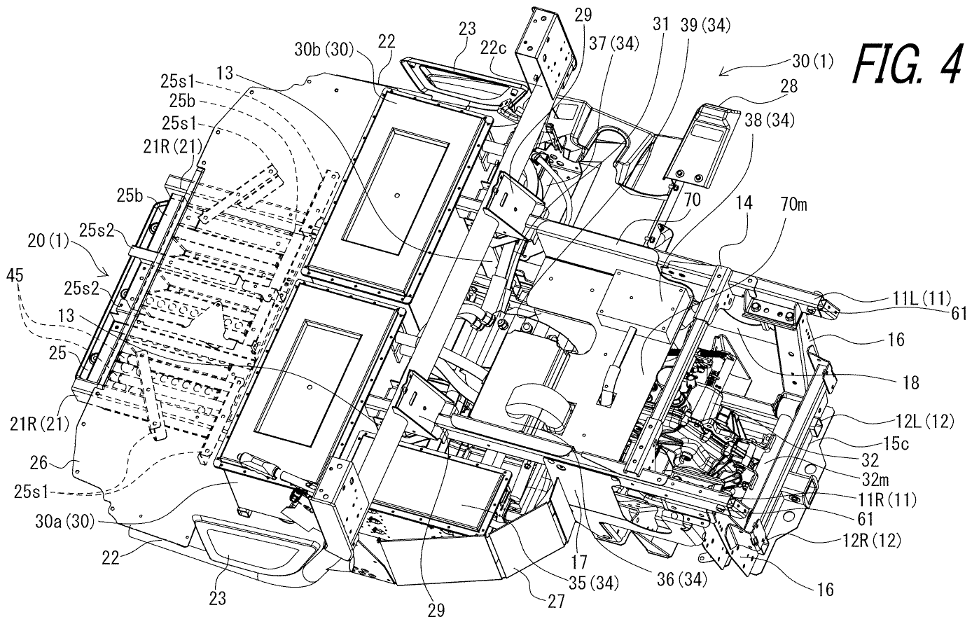

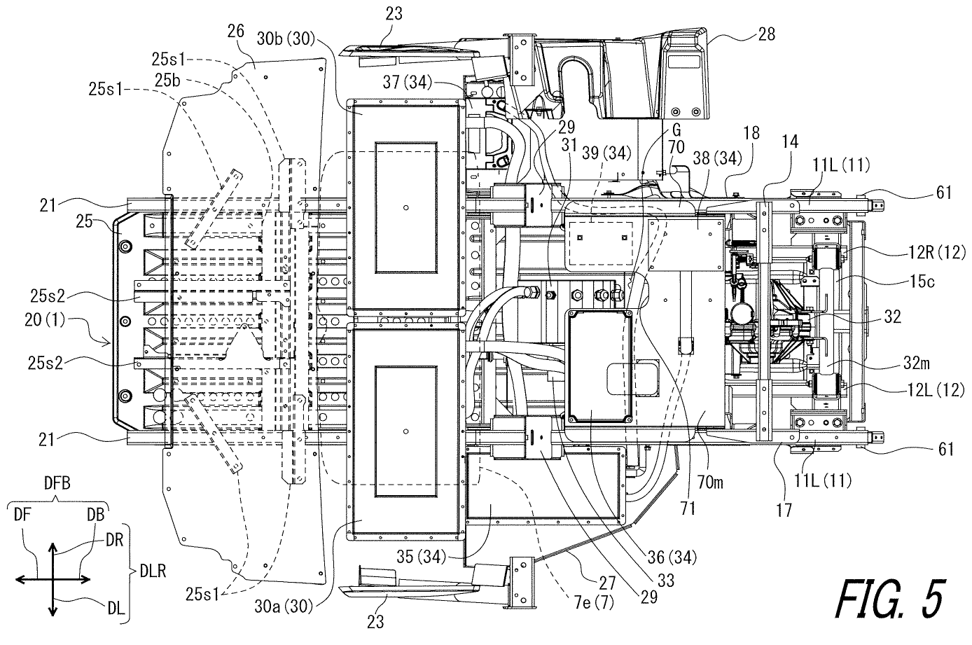

As seen in FIG. 1, the frame body 1 includes a front frame portion 1F, a middle frame portion 20, and a rear frame portion 10. FIG. 4 shows a perspective view of the rear portion of the utility vehicle 100 with the seats 7, the rear wheels 5 and the cargo bed 6 omitted. FIG. 5 shows a plan view of the rear portion of the utility vehicle 100 with the seats 7, the rear wheels 5 and the cargo bed 6 omitted. As seen in FIGS. 1, 4 and 5, the middle frame portion 20 has a roll over protection structure (ROPS) to protect the operator compartment 2. The middle frame portion 20 includes main frames 21, U-shaped bars 22, and side covers 23 to cover left and sides of the at least one battery 30. The main frames 21 are made of square pipes extending in the front-back direction DFB. The main frames 21 are opposite to each other in the left-right direction DLR.

As seen in FIG. 1, the middle frame portion 20 further includes a battery cover 24 to cover top, front, right and left sides of the at least one battery 30 under the seats 7. In FIG. 4, the battery cover 24 is omitted. As shown in FIGS. 4 and 5, the middle frame portion 20 further includes a middle bottom frame 25 spreading across the main frames 21 and a floor frame 26 spreading across bottom portions of the U-shaped bars 22. The middle bottom frame 25 includes stands 25s2 and stands side bars 25b that support the stands 25s2 supporting the floor frame 26. The middle frame portion 20 further includes stands 25s1 provided on the main frames 21 to support the floor frame 26. Accordingly, the floor frame 26 is provided above the main frames 21. As seen in FIGS. 1 and 2, a foot of the driver who sits on the driver's seat 7a is placed on the floor frame 26. The seats 7, which include the driver's seat 7a, are provided on the main frames 21.

The rear frame portion 10 includes a pair of cargo support frames 11, base frames 12, support bars 13, a upper cross bar 14, a rear lower cross bar 15c, and rear support frames 16. The pair of cargo support frames 11 are square pipes extending in the front-back direction DFB and provided opposite to each other in the left-right direction DLR. The pair of cargo support frames 11 includes the bosses 61, thereby the pair of cargo support frames 11 are configured to support the cargo bed 6.

The base frames 12 are coupled to the main frames 21. The base frames 12 are square pipes extending in the front-back direction DFB and provided opposite to each other in the left-right direction DLR. The base frames 12 support the support bars 13 and the rear support frames 16. The support bars 13 and the rear support frames 16 support the pair of cargo support frames 11. In addition, the pair of cargo support frames 11 are supported by the ROPS cross bar 22c via brackets 29. The upper cross bar 14 connects the pair of the cargo support frames 11. The rear lower cross bar 15c connects the base frames 12. The rear frame portion 10 may further include a left rear cover 17 and a right rear cover 18. The left rear cover 17 connects a left one 11L of the cargo support frames 11 and a left one 12L of the base frames 12 to cover a left rear side of the prime mover compartment 3. The right rear cover 18 connects a right one 11R of the cargo support frames 11 and a right one 12R of the base frames 12 to cover a right rear side of the prime mover compartment 3.

### Electric Components Support Structures

As seen in FIGS. 4 and 5, the utility vehicle 100 further includes a left supporting platform 27 configured to support the PDU 35 and a right supporting platform 28 configured to support the additional battery 37. The left supporting platform 27 is connected to a left one 13L of the support bars 13 and the left rear cover 17. The right supporting platform 28 is connected to a right one 13R of the support bars 13 and the right rear cover 18.

As seen in FIGS. 4 and 5, the utility vehicle 100 further includes an electric component support plate 70 having a mounting surface 70m on which at least one electric component 34 is mounted. The electric component support plate 70 is connected to the pair of cargo support frames 11. The electric component support plate 70 extends from the left one 11L of the pair of cargo support frames 11 to the right one 11R of the pair of cargo support frames 11. The at least one electric component 34 that is mounted on the mounting surface 70m includes at least one of the inverter 36 to control the electric motor 31 or the DC-to-DC converter 37. However, the at least one electric component 34 that is mounted on the mounting surface 70m may include any one of the PDU 35, the additional battery 37, or the on-board charger 39.

As shown in FIG. 5, the electric component support plate 70 connects the cargo support frames 11 and is apart from a back end 7e of the seats 7 in the front-back direction DFB such that at least part of the electric motor 31 is viewable through a gap G between the back end 7e of the seats 7 and the electric component support plate 70 as viewed in the vertical direction DV. In FIG. 5, the seats 7 are shown by dotted lines. The electric component support plate 70 has a cutout 71 at a front end of the electric component support plate 70 such that the electric motor 31 is viewable through the cutout 71 as viewed in the vertical direction DV.

The inverter 36 is provided on the mounting surface 70m adjacent to the cutout 71. The inverter 36 overlaps with the electric motor 31 as viewed in the vertical direction DV such that the electric component support plate 70 is sandwiched by the inverter 36 and the electric motor 31 in the vertical direction DV. The DC-to-DC converter 38 is disposed on the mounting surface 70m behind the electric motor 31 in the front-back direction DFB.

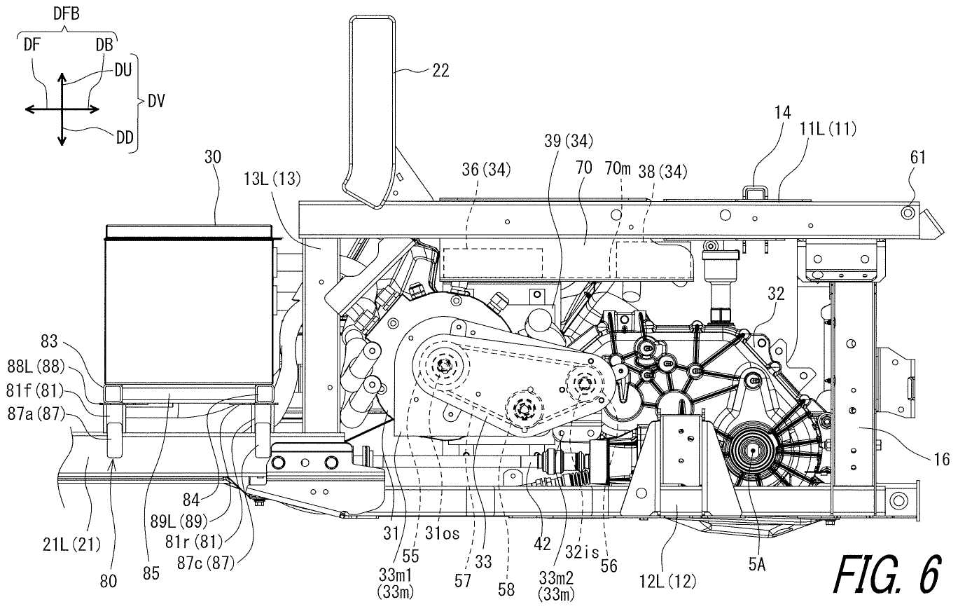

The electric component support plate 70 has a U-shaped bent plate, tops of which are mounted on the cargo support frames 11. The mounting surface 70m is the bottom of the U-shaped bent plate. FIG. 6 shows a left side view of the rear portion of the utility vehicle 100 with the rear wheels 5, the cargo bed 6, the PDU 35, the left rear cover 17, and the left supporting platform 27 omitted. As shown in FIG. 6, the mounting surface 70m is below the pair of cargo support frames 11 and above the electric motor 31, the transmission 32, and the additional speed changer 33 in the vertical direction DV.

FIG. 6 shows an internal structure of the additional speed changer 33 shown by dotted lines. As shown in FIG. 6, the electric motor 31 including an output shaft 31os which the electric motor 31 is configured to rotate and which extends in the left-right direction DLR. The transmission 32 includes an input shaft 32is to receive a driving power of the output shaft 31os to output a rotational power of the rear wheels 5. The input shaft 32is extends in the left-right direction DLR such that the input shaft 32is is apart from the output shaft 31os in the front-back direction DFB and substantially parallel to the output shaft 31os.

The additional speed changer 33 includes a drive pulley 55, a driven pulley 56, a transmission belt 57, and a tensioning pulley 58. The drive pulley 55 is rotatable together with the output shaft 31os of the electric motor 31. The driven pulley 56 is rotatable together with the input shaft 32is of the transmission 32. The transmission belt 57 is configured to transmitting power from the drive pulley 55 to the driven pulley 56. The tensioning pulley 58 engages with the transmission belt 57 to ensure efficient power transfer and prevent belt slippage.

As shown in FIG. 6, the input shaft 32is of the transmission 32 is provided between the output shaft 31os of the electric motor 31 and a rotational axis 5A of the rear wheels 5 in the front-back direction DFB. The rear wheels 5 are rotatable around the rotational axis 5A.

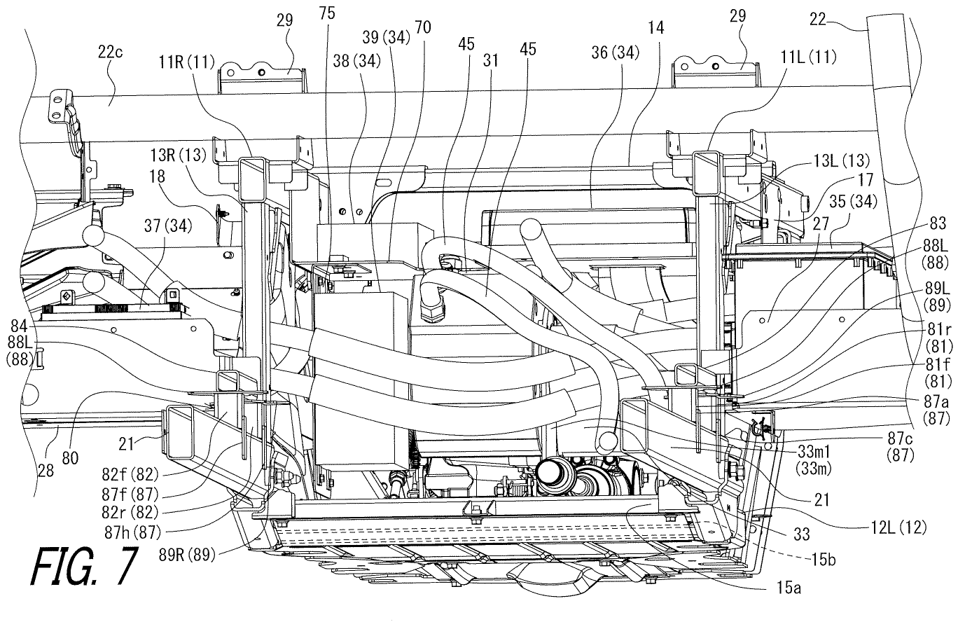

FIG. 7 shows a front upward perspective view of the prime mover compartment 3 of the utility vehicle 100 with the main frames 21 attached. As shown in FIG. 7, the utility vehicle 100 further includes an auxiliary support plate 75. The auxiliary support plate 75 protrudes from the electric component support plate 70 opposite to the cargo support frames 11 in the vertical direction DV. More specifically, the auxiliary support plate 75 is an angle plate forming one leg connected to the bottom of the electric component support plate 70 and another leg extending in the downward direction DD. The on-board charger 29 is provided on the auxiliary support plate 75. More specifically, the on-board charger 29 is provided on the other leg extending in the downward direction DD. The one leg of the auxiliary support plate 75 is connected to the bottom of the electric component support plate 70 by fasters, e.g. bolt-and-nuts. The on-board charger 29 is connected to the other leg of the auxiliary support plate 75 by fasters, e.g. bolt-and-nuts.

### Support Structures of the Electric Motor and Transmission

As shown in FIG. 7, the rear frame portion 10 includes a front lower cross bar 15a and a middle lower cross bar 15b. The front lower cross bar 15a and the middle lower cross bar 15b each connect the base frames 12. As shown in FIGS. 6 and 7, the utility vehicle 100 further includes a prime mover mounting bracket 33m between the electric motor 31 and the additional speed changer 33 and between the transmission 32 and the additional speed changer 33. As shown in FIG. 6, the prime mover mounting bracket 33m includes the motor mounting portion 33m1 via which the electric motor 31 is connected to the additional speed changer 33, and the transmission mounting portion 33m2 via which the transmission 32 is connected to the additional speed changer 33. The motor mounting portion 33m1 and the transmission mounting portion 33m2 are integrated into the prime mover mounting bracket 33m, which is a single bracket. As shown in FIG. 4, the utility vehicle 100 further includes a transmission mounting bracket 32m provided on the base frames 12 to support the rear portion of the transmission 32. The utility vehicle may further include at least one additional bracket provided on at least one of the front lower cross bar 15a and the middle lower cross bar 15b to support at least one of the electric motor 31, the prime mover mounting bracket 33m, and the front portion of transmission 32.

### PDU Position

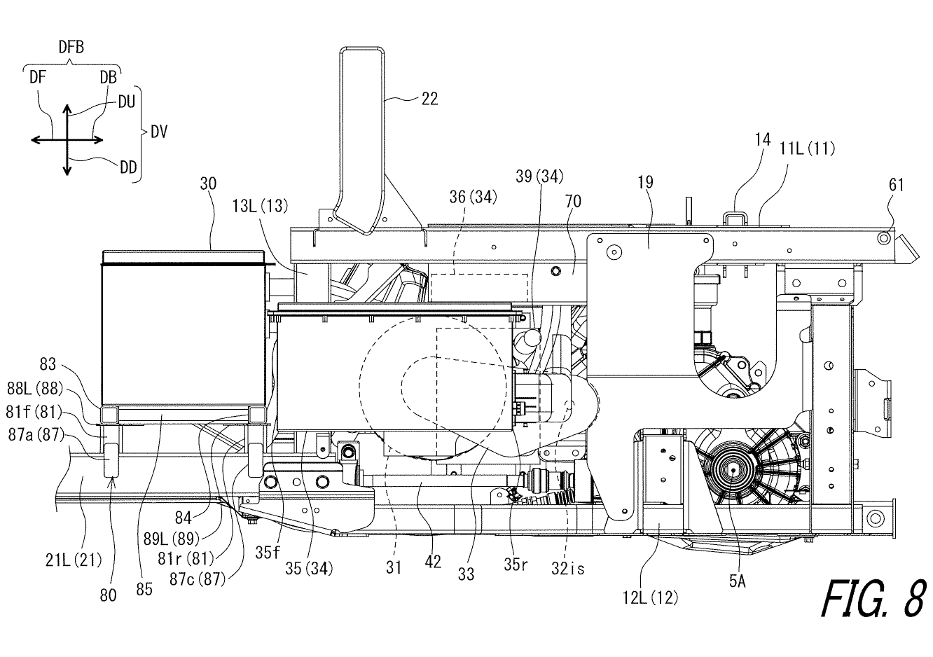

FIG. 8 shows a left side view of the rear portion of the utility vehicle 100 with the rear wheels 5, the cargo bed 6, and the left supporting platform 27 omitted. Since the PDU 35 is supported by the left supporting platform 27, as shown in FIG. 8, the PDU 35 overlaps with the electric motor 31 and the on-board charger 39 as viewed in the left-right direction DLR. The PDU 35 is provided between the at least one battery 30 and the input shaft 32 of the transmission 32 in the front-back direction DFB. The PDU 35 is provided such that a front end of the inverter 36 is positioned between a front end 53f of the PDU 53 and a rear end 53r of the PDU in the front-back direction DFB.

### Battery Mounting Unit

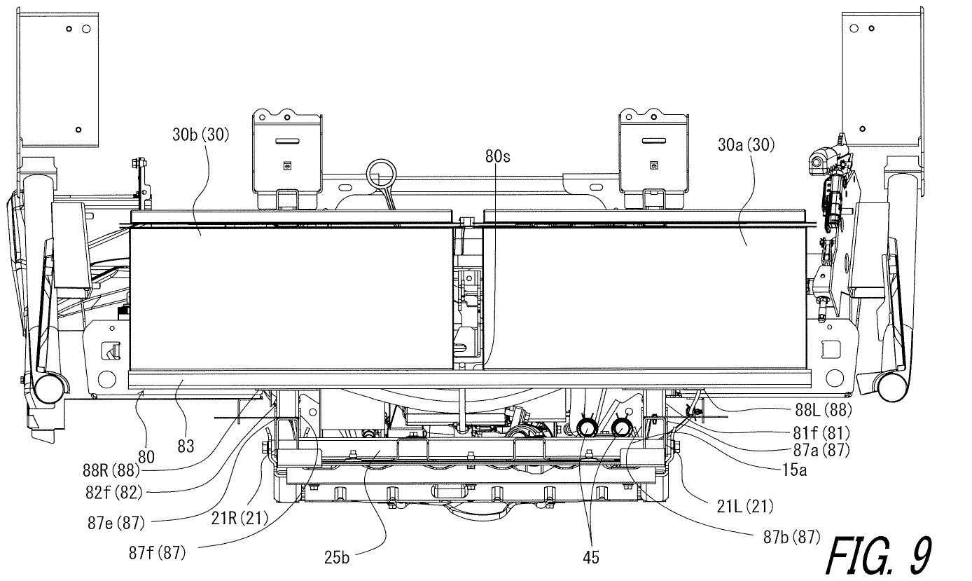

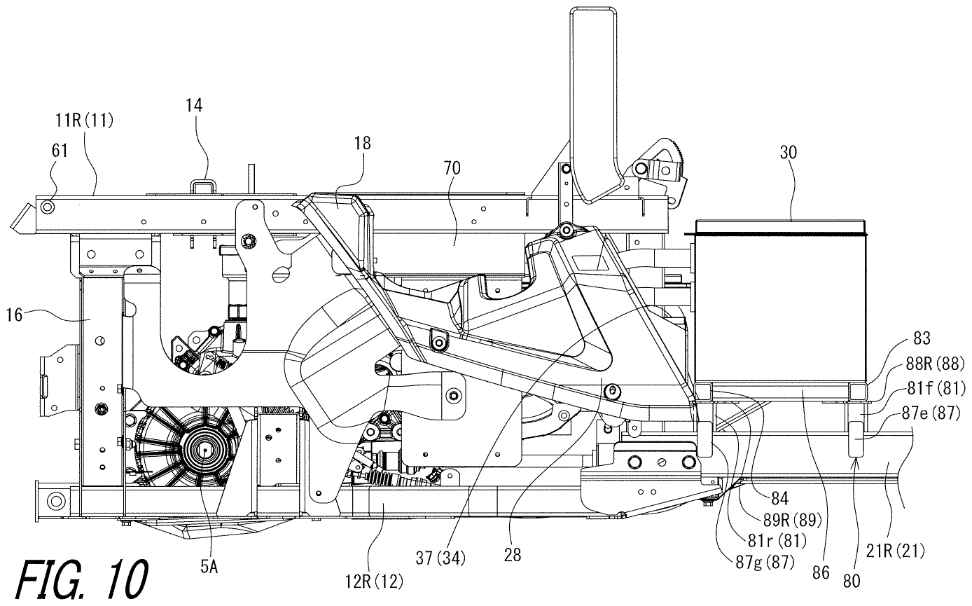

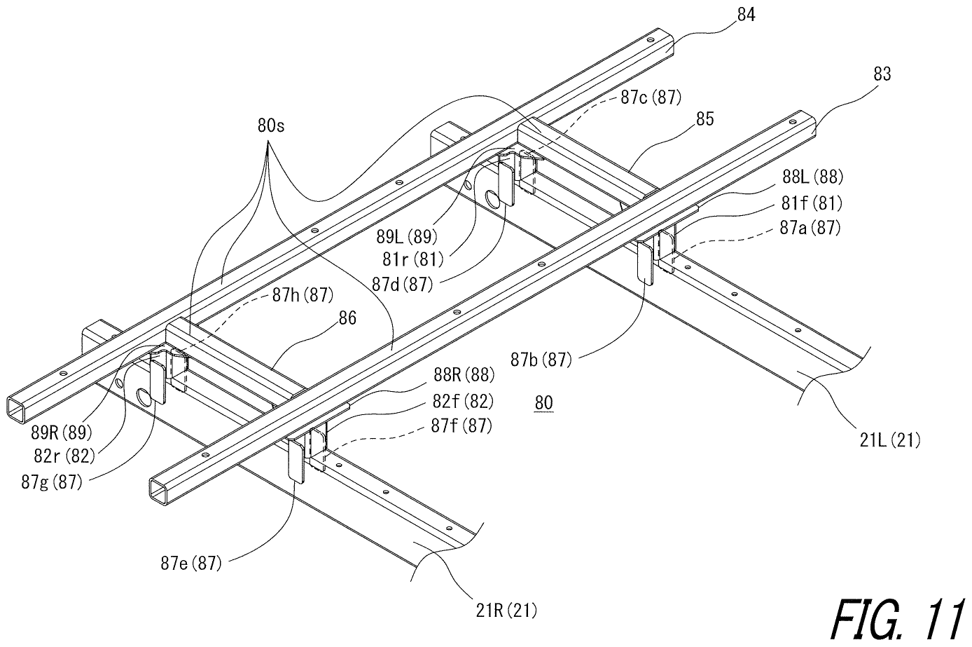

The utility vehicle 100 further includes a battery mounting unit 80 to support the at least one battery 30. As seen in FIG. 1, the at least one battery 30 is provided between the battery mounting unit 80 and the driver's seat 7a in the vertical direction DV. FIG. 9 shows a front view of the at least one battery 30 and the battery mounting unit 80. FIG. 10 shows a right side view of the rear portion of the utility vehicle 100 with the rear wheels 5 and the cargo bed 6 omitted. FIG. 11 shows a perspective view of the battery mounting unit 80. As shown in FIGS. 6 to 11, the battery mounting unit 80 si supported by the main frames 21. The battery mounting unit 80 includes at least two first side legs 81, at least two second side legs 82, a first longitudinal beam 83, a second longitudinal beam 84, a first lateral beam 85, a second lateral beam 86, first connecting plates 87, second connecting plates 88, and third connecting plates 89.

The at least two first side legs 81 and the at least two second side legs 82 are provided on the main frames 21. The at least two first side legs 81 and the at least two second side legs 82 extend in the upward direction DU from the main frames 21. The at least two second side legs 82 are being opposite to the at least two first side legs 81 in the left-right direction DLR. Hereinafter, a left one of the main frames 21 is referred to as a left main frame 21L, and a right one of the main frames 21 is referred to as a right main frame 21R. The at least two first side legs 81 are provided on the left main frame 21L, and the at least two second side legs 82 are provided on the right main frame 21R.

Each of the at least two first side legs 81 and the at least two second side legs 82 are aligned in the front-back direction DFB. In this embodiment, the at least two first side legs 81 include a front first side leg 81f and a rear first side leg 81r. However, the at least two first side legs 81 may further include an additional first side leg between the front first side leg 81f and the rear first side leg 81r in the front-back direction DFB. In this embodiment, the at least two second side legs 82 include a front second side leg 82f and a rear second side leg 82r. However, the at least two second side legs 82 may further include an additional second side leg between the front second side leg 82f and the rear second side leg 82r in the front-back direction DFB.

The first longitudinal beam 83, the second longitudinal beam 84, the first lateral beam 85, the second lateral beam 86 each are provided above the main frames 21 in the vertical direction DV to support at least one battery 30. The first longitudinal beam 83 extends in one direction of the front-back direction DFB and the left-right direction DLR and supported by at least two of the at least two first side legs 81 and the at least two second side legs 82. The second longitudinal beam 84 extends in the one direction and supported by at least two of the at least two first side legs 81 and the at least two second side legs 82.

The first lateral beam 85 and the second lateral beam 86 are separated from each other in the one direction and each connect the first longitudinal beam 83 and the second longitudinal beam 84. The first lateral beam 85 and the second lateral beam 86 are separated from each other in the one direction and each connect the first longitudinal beam 83 and the second longitudinal beam 84.

In this embodiment, the one direction is the left-right direction DLR. The first longitudinal beam 83 is provided over the front first side leg 81f and the front second side leg 82f in the vertical direction DV. The second longitudinal beam 84 is provided over the rear first side leg 81r and the rear second side leg 82r in the vertical direction DV. The first lateral beam 85 is provided over the left main frame 21L in the vertical direction DV. The second lateral beam 86 is provided over the left main frame 21L in the vertical direction DV.

However, the one direction can be the front-back direction DFB. The first longitudinal beam 83 can be provided over the at least two first side legs 81. The second longitudinal beam 84 can be provided over the at least two second side legs 82 in the vertical direction DV. Each of the first lateral beam 85 and the second lateral beam 86 can be provided between the main frames 21 as viewed in the vertical direction DV.

As seen in FIGS. 6, 8, and 10, the first longitudinal beam 83 and the second longitudinal beam 84 are configured to support edges of a bottom surface of the at least one battery 30. However, the first lateral beam 85 and the second lateral beam 86 can be configured to support edges of a bottom surface of the at least one battery 30. Alternatively, the first longitudinal beam 83, the second longitudinal beam 84, the first lateral beam 85, and the second lateral beam 86 can be configured to support edges of a bottom surface of the at least one battery 30.

FIG. 7 shows the battery mounting unit 80 with the first longitudinal beam 83 and the second longitudinal beam 84 omitted. As shown in FIGS. 6 to 8, the first longitudinal beam 83, the second longitudinal beam 84, the first lateral beam 85, and the second lateral beam 86 each are made of square pipes. As seen in FIGS. 6 to 11, the at least two first side legs 81 and the at least two second side legs 82 each are made of square pipes.

Furthermore, as seen in FIGS. 6 to 11, the first connecting plates 87 connect the main frames 21 and respective ones of the at least two first side legs 81 and the at least two second side legs 82. More specifically, the first connecting plates 87 include a connecting plate 87a and a connecting plate 87b that connect the front first side leg 81f and the left main frame 21L by welding. The first connecting plates 87 include a connecting plate 87c and a connecting plate 87d that connect the rear first side leg 81r and the left main frame 21L by welding. The first connecting plates 87 include a connecting plate 87e and a connecting plate 87f that connect the front second side leg 82f and the right main frame 21R by welding. The first connecting plates 87 include a connecting plate 87g and a connecting plate 87h that connect the rear second side leg 82r and the right main frame 21R by welding. If the at least two first side legs 81 have an additional first side leg, the first connecting plates 87 may further include two additional connecting plates for connecting the additional first side leg to the left main frame 21L. If the at least two second side legs 82 have an additional second side leg, the first connecting plates 87 may further include two additional connecting plates for connecting the additional second side leg to the right main frame 21R.

The second connecting plates 88 connect the first longitudinal beam 83 and respective ones of the first lateral beam 85 and the second lateral beam 86. More specifically, the second connecting plates 88 include an upper front-left connecting plate 88L and an upper front-right connecting plate 88R. The second connecting plates 88 are connected to respective ones of the at least two first side legs 81 and the at least two second side legs 82. More specifically, the upper front-left connecting plate 88L is connected to the front first side leg 81f. The upper front-right connecting plate 88R is connected to the front second side leg 82f. If any connection of the first longitudinal beam 83 to any of the at least two first side legs 81 and the at least two second side legs 82 are different from connections of the first longitudinal beam 83 to the first lateral beam 85 and the second lateral beam 86, the second connecting plates 88 may further include additional second connecting plates for such a connection.

The third connecting plates 89 connect the second longitudinal beam 84 and respective ones of the first lateral beam 85 and the second lateral beam 86. More specifically, the third connecting plates 89 include an upper rear-left connecting plate 89L and an upper rear-right connecting plate 89R. The third connecting plates 89 are connected to respective ones of the at least two first side legs 81 and the at least two second side legs 82. More specifically, the upper rear-left connecting plate 89L is connected to the rear first side leg 81r. The upper rear-right connecting plate 89R is connected to the rear second side leg 82r. If any connection of the second longitudinal beam 84 to any of the at least two first side legs 81 and the at least two second side legs 82 are different from connections of the second longitudinal beam 84 to the first lateral beam 85 and the second lateral beam 86, the third connecting plates 89 may further include additional third connecting plates for such a connection. Due to the above structure, the battery mounting unit 80 can reduce the vibration transmitted to the at least one battery 30 from the frame body 1.

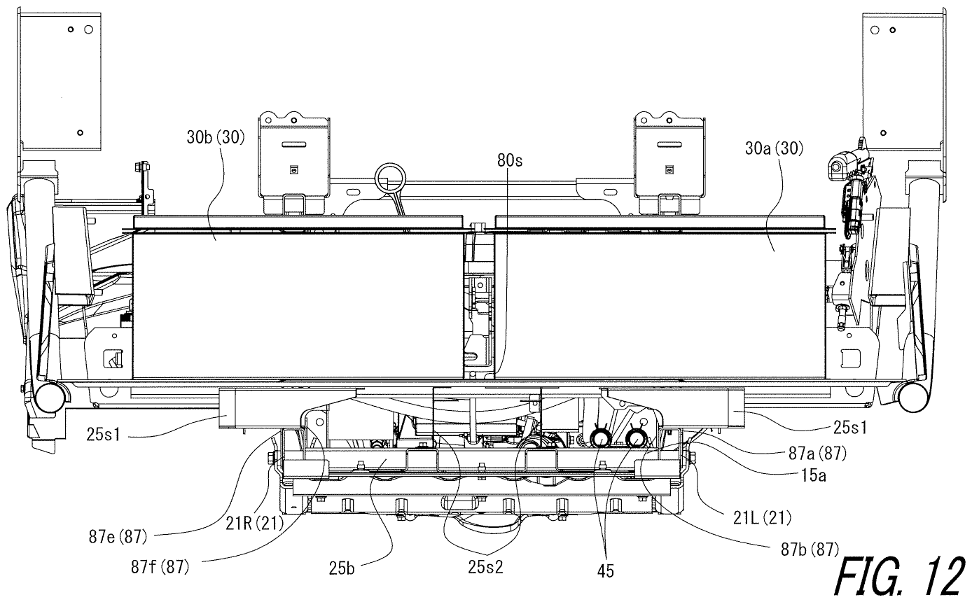

As shown in FIG. 11, the battery mounting unit 80 has a mounting surface 80s which is constituted by upper surfaces of the first longitudinal beam 83, the second longitudinal beam 84, the first lateral beam 85, and the second lateral beam 86. FIG. 12 shows a front view of the at least one battery 30 and the battery mounting unit 80 with the floor frame 26 and stands 25s1 and 25s2 to support the floor frame 26. As shown in FIG. 12, the mounting surface 80s of the battery mounting unit 80 on which the at least one battery 30 is mounted is higher than or as high as the floor frame 26 in the vertical direction DV. The battery mounting unit 80 raises the bottom of the at least one battery to enhance cooling performance for the at least one battery 30.

As shown in FIG. 1, the utility vehicle 100 includes a radiator 44 disposed on the front frame portion 1F to cool coolant of the electric motor 31. As shown in FIGS. 4, 7, 9, and 12, the utility vehicle 100 further includes coolant hoses through which the coolant is configured to flow between the electric motor 31 and the radiator 44. As shown in FIGS. 4, 9, and 12, the coolant hoses 45 pass under the floor frame 26. More specifically, the coolant hoses 45 pass through a gap between the middle bottom frame 25 and the floor frame 26. Furthermore, the front wheel transmission line 43 passes under the floor frame 26. More specifically, the front wheel transmission line 43 passes through a gap defined by the middle bottom frame 25 and the floor frame 26 and the stands 25s2.

The present application refers to words “include” and derivatives as nonrestrictive terms for description of provision of constituent elements, without exclusion of any other constituent element not referred to in the present application. The same applies to words “have”, “provided with”, and derivatives thereof.

Expressions “member”, “part”, “element”, “body”, and “structure” may have a plurality of meanings indicating a single portion and a plurality of portions.

Ordinal numbers “first”, “second”, and the like are terms for simple distinction among configurations, without having any other meaning (e.g. specific order). For example, provision of a “first element” does not indicate provision of a “second element”, and provision of the “second element” does not indicate provision of the “first element”.

Expressions “substantially”, “approximately”, “about”, and the like indicating degrees may each have a rational deviation not significantly changing a final result. All the numerical values referred to in the present application may be interpreted as including any one of the expressions “substantially”, “approximately”, “about”, and the like.

In the present application, an expression “at least one of A and B” is interpreted to encompass (1) only A, (2) only B, and (3) both A and B.

In view of the above disclosure, the present invention can obviously include various modifications and alterations. The present invention may thus be implemented in any manner different from those specifically disclosed in the present application without departing from the spirit of the preset invention.

What is claimed is:

1. A utility vehicle comprising:
a frame body;
a seat which is provided on the frame body and on which a person is seated;
a cargo bed mounted to the frame body in back of the seat, the seat and the cargo bed being aligned in a front-back direction;
rear wheels aligned in a left-right direction perpendicular to front-back direction, the rear wheels being rotatably mounted to the frame body under the cargo bed in a vertical direction perpendicular to the front-back direction and to the left-right direction;
an electric motor provided on the frame body under the cargo bed in the vertical direction such that the electric motor does not overlap with the rear wheels as viewed in the left-right direction, the electric motor including an output shaft which the electric motor is configured to rotate and which extends in the left-right direction;
a transmission mounted to the frame body under the cargo bed in the vertical direction, the transmission including an input shaft to receive a driving power of the output shaft to output a rotational power of the rear wheels, the input shaft extending in the left-right direction such that the input shaft is apart from the output shaft in the front-back direction and substantially parallel to the output shaft; and
at least one battery electrically connected to the electric motor and provided under the seat in the vertical direction such that the electric motor is provided between the at least one battery and the transmission in the front-back direction.

2. The utility vehicle according to claim 1, further comprising:
an electric component support plate having a mounting surface on which at least one electric component is mounted,
wherein the frame body includes a pair of cargo support frames provided opposite to each other in the left-right direction and configured to support the cargo bed, and
wherein the electric component support plate is connected to the pair of cargo support frames such that the mounting surface is below the pair of cargo support frames and above the electric motor and the transmission in the vertical direction.

3. The utility vehicle according to claim 2,
wherein the electric component support plate connects the cargo support frames and is apart from a back end of the seat in the front-back direction such that at least part of the electric motor is viewable through a gap between the back end of the seat and the electric component support plate as viewed in the vertical direction.

4. The utility vehicle according to claim 3,
wherein the at least one electric component includes at least one of an inverter to control the electric motor or an DC-to-DC converter.

5. The utility vehicle according to claim 3,
wherein the electric component support plate has a cutout at a front end of the electric component support plate such that the electric motor is viewable through the cutout as viewed in the vertical direction.

6. The utility vehicle according to claim 4,
wherein the electric component support plate has a cutout at a front end of the electric component support plate such that the electric motor is viewable through the cutout as viewed in the vertical direction.

7. The utility vehicle according to claim 6,
wherein the inverter is provided on the mounting surface adjacent to the cutout.

8. The utility vehicle according to claim 7,
wherein the inverter overlaps with the electric motor as viewed in the vertical direction such that the electric component support plate is sandwiched by the inverter and the electric motor in the vertical direction.

9. The utility vehicle according to claim 7,
wherein the input shaft of the transmission is provided between the output shaft of the electric motor and a rotational axis of the rear wheels in the front-back direction, the rear wheels being rotatable around the rotational axis.

10. The utility vehicle according to claim 4, further comprising:
an auxiliary support plate protruding from the electric component support plate opposite to the cargo support frames in the vertical direction; and
an on-board charger provided on the auxiliary support plate to generate electricity using power from the electric motor.

11. The utility vehicle according to claim 10, further comprising:
a power distribution unit configured to control the inverter and provided between the at least one battery and the input shaft of the transmission in the front-back direction such that the power distribution unit overlaps with the on-board charger and the electric motor as viewed in the left-right direction.

12. The utility vehicle according to claim 11,
wherein the power distribution unit is provided such that a front end of the inverter is positioned between a front end of the power distribution unit and a rear end of the power distribution unit in the front-back direction.
